(19) United States
(12) Patent Application Publication
(10) Pub. No.: US 2017/0146227 A1
(43) Pub. Date: May 25, 2017

(54) ILLUMINATED CORBEL

(71) Applicant: OSBORNE WOOD PRODUCTS, INC., Toccoa, GA (US)

(72) Inventor: Christian SMEDBERG, Clarkesville, GA (US)

(73) Assignee: OSBORNE WOOD PRODUCTS, INC., Toccoa, GA (US)

(21) Appl. No.: 15/360,024

(22) Filed: Nov. 23, 2016

Related U.S. Application Data
(60) Provisional application No. 62/259,944, filed on Nov. 25, 2015.

(51) Int. Cl. F21V 33/00; F21V 3/00; F21V 17/12; E04F 19/00

(52) U.S. Cl. CPC F21V 33/006; E04F 19/00; F21V 3/00; F21V 17/12; F21Y 2115/10

(57) ABSTRACT

An illuminated corbel includes first and second wood members connected together at proximal ends thereof and extending transverse to one another to form a generally L-shaped structure. The illuminated corbel further includes a connecting wood member extending between distal portions of the first and second wood members to define a cavity between the first and second wood members and the connecting member. At least one wood sheet member substantially covers one side of the cavity. Further, one or more electric lamps are mounted within the cavity for illuminating the interior of the cavity. The first and second wood members, the connecting wood member, and the sheet member are arranged and configured to permit at least some light from the electric lamp to emanate from within the corbel and be externally visible.

### CROSS REFERENCE TO RELATED APPLICATIONS

This application claims the priority benefit of U.S. Provisional Patent Application Ser. No. 62/259,944, filed Nov. 25, 2015. The provisional patent application is incorporated herein by reference in its entirety to provide continuity of disclosure and for all purposes.

### SUMMARY OF THE INVENTION

Briefly described, in a first preferred form the present invention relates to an illuminated corbel that includes first and second wood members connected together at proximal ends thereof and extending transverse to one another to form a generally L-shaped structure. The illuminated corbel further includes a connecting wood member extending between distal portions of the first and second wood members to define a cavity between the first and second wood members and the connecting member. At least one wood sheet member substantially covers one side of the cavity. Further, one or more electric lamps are mounted within the cavity for illuminating the interior of the cavity. The first and second wood members, the connecting wood member, and the sheet member are arranged and configured to permit at least some light from the electric lamp to emanate from within the corbel and be externally visible.

Preferably, the sheet member covers the cavity in a manner to avoid sealing the cavity completely against the escape of any light, thus permitting some light to escape from within the cavity.

In one preferred illustrative example, the sheet member is opaque. In another illustrative example, the sheet member is translucent.

In another illustrative example, the sheet member is a non-wood sheet, such as plastic.

Preferably, the sheet member is fitted within a recess formed in the first and second wood members and the connecting wood member.

Also, preferably, the sheet member is fitted within a rebate formed in the first and second wood member and the connecting wood member.

Preferably, the one or more electric lamps comprise a strip of LED lamps.

While an illuminated corbel is shown and described, it will be appreciated that the invention also relates to similar furniture/architectural elements, such as brackets, feet and legs.

### BRIEF DESCRIPTION OF THE DRAWING FIGURES

FIG. 1 is a perspective illustration of an illuminated corbel according to a first preferred example form of the present invention, showing the corbel lit up.

FIG. 1A is a perspective illustration (photo) of the illuminated corbel of FIG. 1.

FIG. 2 is a perspective illustration of the illuminated corbel of FIG. 1, with a cover portion thereof removed to illustrate the interior of the illuminated corbel and showing the corbel's interior lamp lit.

FIG. 2A is a perspective illustration (photo) of the illuminated corbel of FIG. 2.

FIG. 3A is a side view of the illuminated corbel of FIG. 1, with a cover portion thereof removed to illustrate the interior of the illuminated corbel.

FIG. 3B is a side view of the illuminated corbel of FIG. 1, including a cover portion.

FIG. 3C is a front view of the illuminated corbel of FIG. 1, including a cover portion.

FIG. 3D is a back view of the illuminated corbel of FIG. 1, including a cover portion.

FIG. 3E is a sectional view of the illuminated corbel of FIG. 1, taken along section line C-C of FIG. 3F.

FIG. 3F is a side view of the illuminated corbel of FIG. 1.

FIG. 4A is a side view of another illuminated corbel, with a cover portion thereof removed to illustrate the interior of the illuminated corbel.

FIG. 4B is a side view of the illuminated corbel of FIG. 4A, including a cover portion.

FIG. 4C is a front view of the illuminated corbel of FIG. 4A, including a cover portion.

FIG. 4D is a back view of the illuminated corbel of FIG. 4A, including a cover portion.

FIG. 4E is a sectional view of the illuminated corbel of FIG. 4A, taken along section line C-C of FIG. 3F.

FIG. 4F is a side view of the illuminated corbel of FIG. 4A.

FIG. 5 is a schematic sectional illustration of the illuminated corbel of FIG. 1, showing a cover portion thereof fitted within a rebate (recess) portion of the wood frame and showing a standoff dowel holding the cover portion from resting against the surface of the rebate, thereby allowing light from the illustrated LED's to emanate from between the cover and the wood frame.

### DETAILED DESCRIPTION

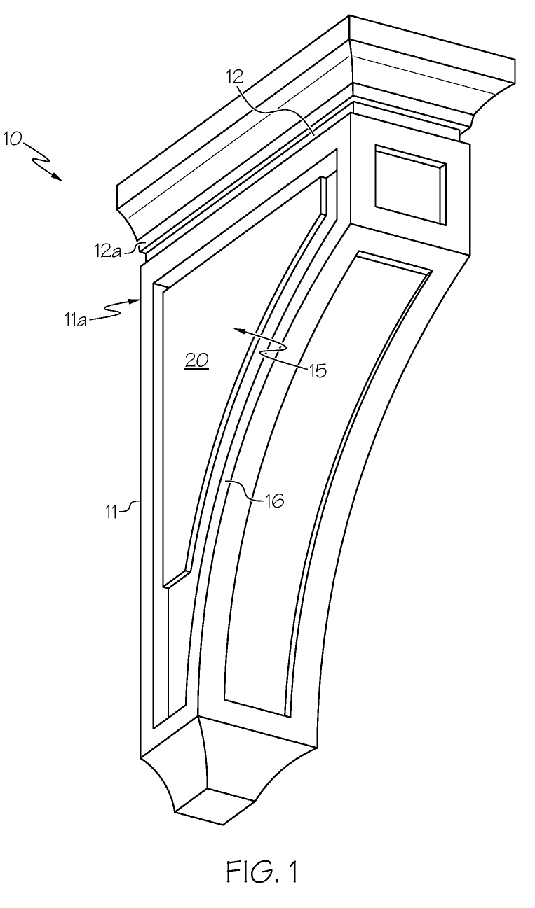

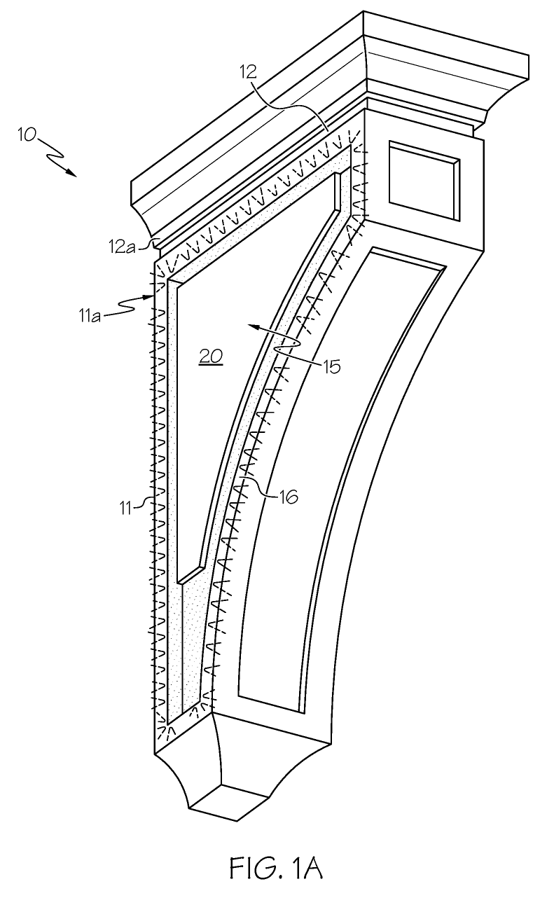

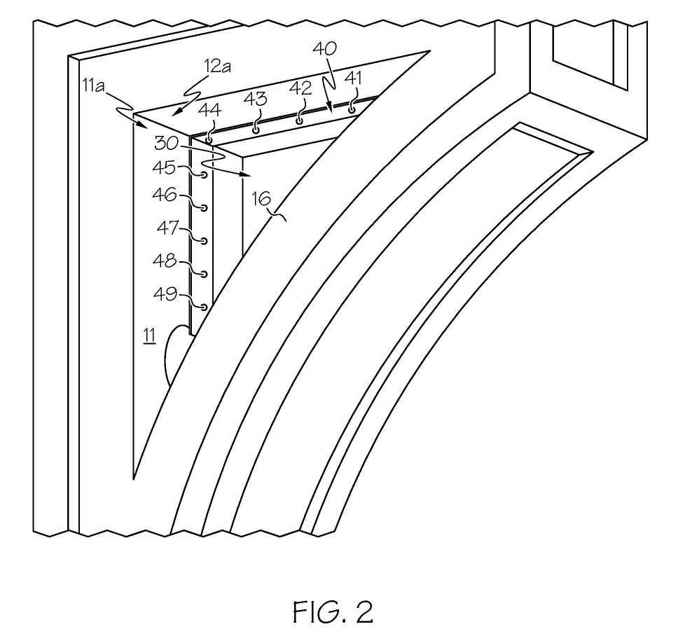

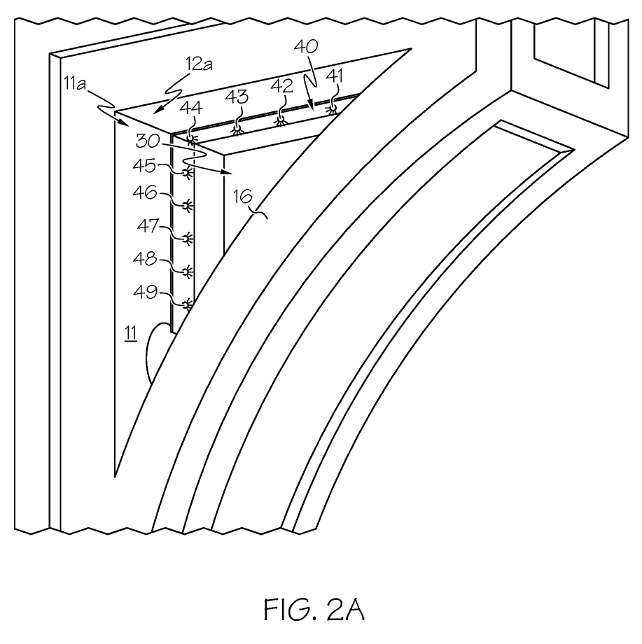

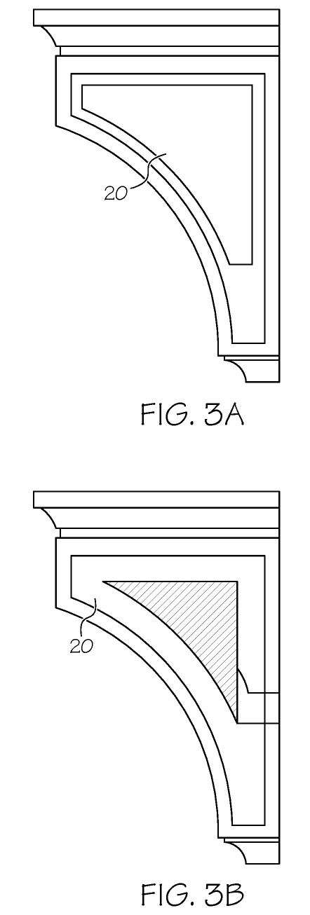

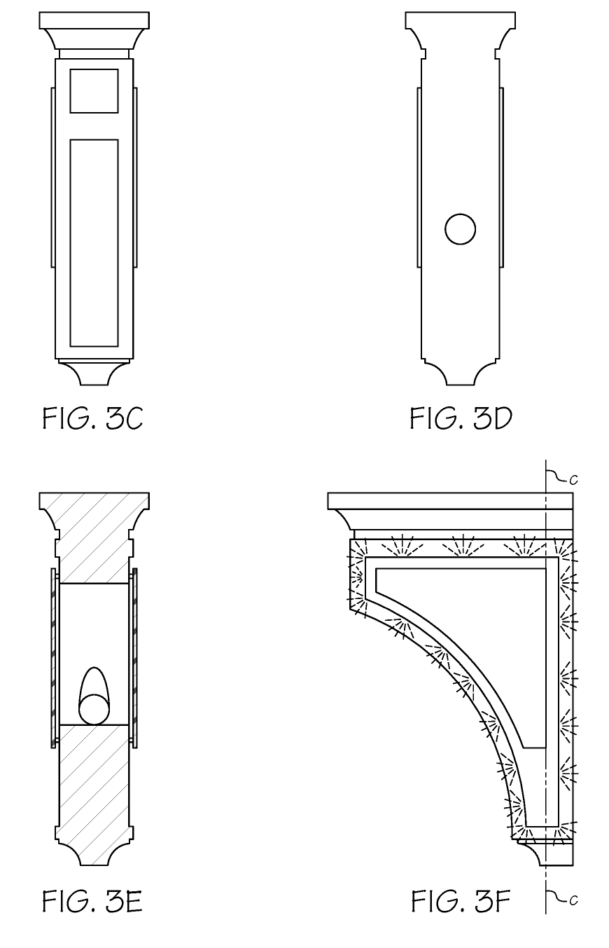

Referring now to the drawing figures, in which like reference numerals represent like parts throughout the several views, FIGS. 1 through 3F show an illuminated corbel 10 that includes first and second wood members 11, 12 connected together at proximal ends 11a, 12a thereof and extending transverse to one another to form a generally L-shaped structure 15. The illuminated corbel further includes a connecting wood member 16 extending between distal portions 11b, 12b of the first and second wood members 11, 12 to define a cavity 30 between the first and second wood members 11, 12 and the connecting member 16. At least one wood sheet member 20 substantially covers one side of the cavity. Here, the illustrative sheet member 20 is generally triangular shaped, with a curved edge along one side thereof to mirror the contour of the corbel's shape overall. However, those skilled in the art will recognize that various shapes can be used for the corbel and/or the cover, as desired. In one preferred illustrative example, the sheet member (cover) 20 is opaque. In another illustrative example, the sheet member 20 is translucent. The translucency can be provided by making the cover of a translucent material. Moreover, such can be decorated with various designs. The opposite side cover can be opaque or translucent. Thus, two translucent covers can be incorporated in the corbel.

Preferably, the sheet member or cover 20 is fitted within a recess formed in the first and second wood members 11, 12 and the connecting wood member 16. In particular, preferably the sheet member 20 is fitted within a rebate 22 formed in the first and second wood member 11, 12 and the connecting wood member 16.

Preferably, the first and second wood members 11, 12 and the connecting wood member 16 define an interior cavity 30. Further, one or more electric lamps 41-49 are provided on a strip 40 and mounted within the cavity 30 for illuminating the interior of the cavity 30. Preferably, the lamp strip 40 comprises a strip of LED lamps. The first and second wood members 11, 12, the connecting wood member 16, and the sheet member 20 are arranged and configured to permit at least some light from the electric lamp strip 40 to emanate from within the corbel and be externally visible.

Preferably, the sheet member 20 covers the cavity 30 in a manner to avoid sealing the cavity completely against the escape of all light, thus permitting some light to escape from within the cavity 30. This can be accomplished in a number of ways. One way is illustrated in the figures in which a series of standoff dowels are positioned in the rebate and the sheet member/cover 20 rests atop the ends of the dowels. For example, FIG. 5 illustrates one of the standoff dowels 32 sunk into the exterior wood frame of the corbel 10 (into one of the wood members 11, 12, 16). Other features can be used to keep the sheet member 20 from completely sealing the cavity 30, such as ledges, feet, brackets, etc., formed in or attached to the first and second wood members 11, 12, the connecting wood member 16.

Unshown screws can be driven through the cover and into the exterior wood frame to secure the cover in place. Alternatively, the cover can be glued or nailed or otherwise permanently affixed in place. Other non-permanent attachment elements can be used to secure the cover in place in a manner to allow the cover 20 to be removed, as for replacing the lamps within the interior of the cavity.

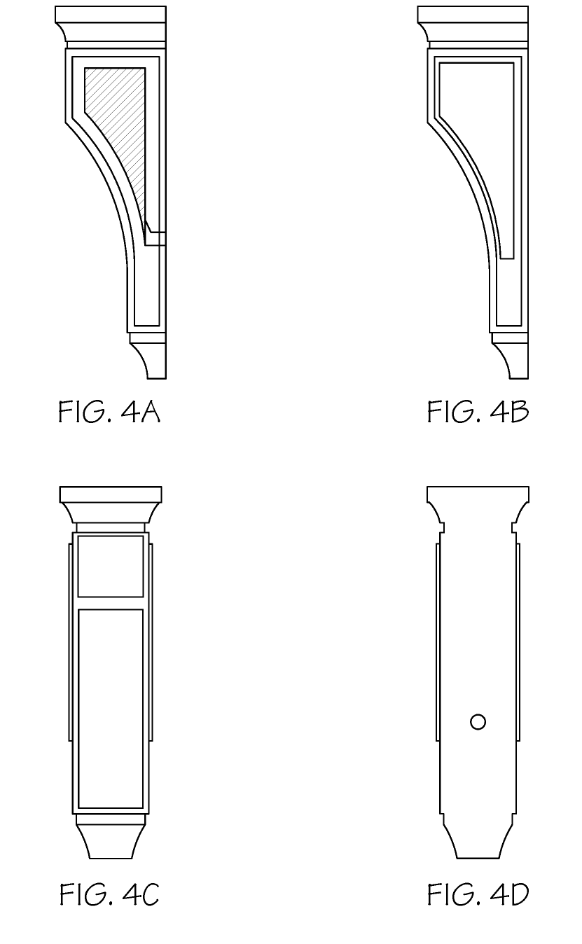

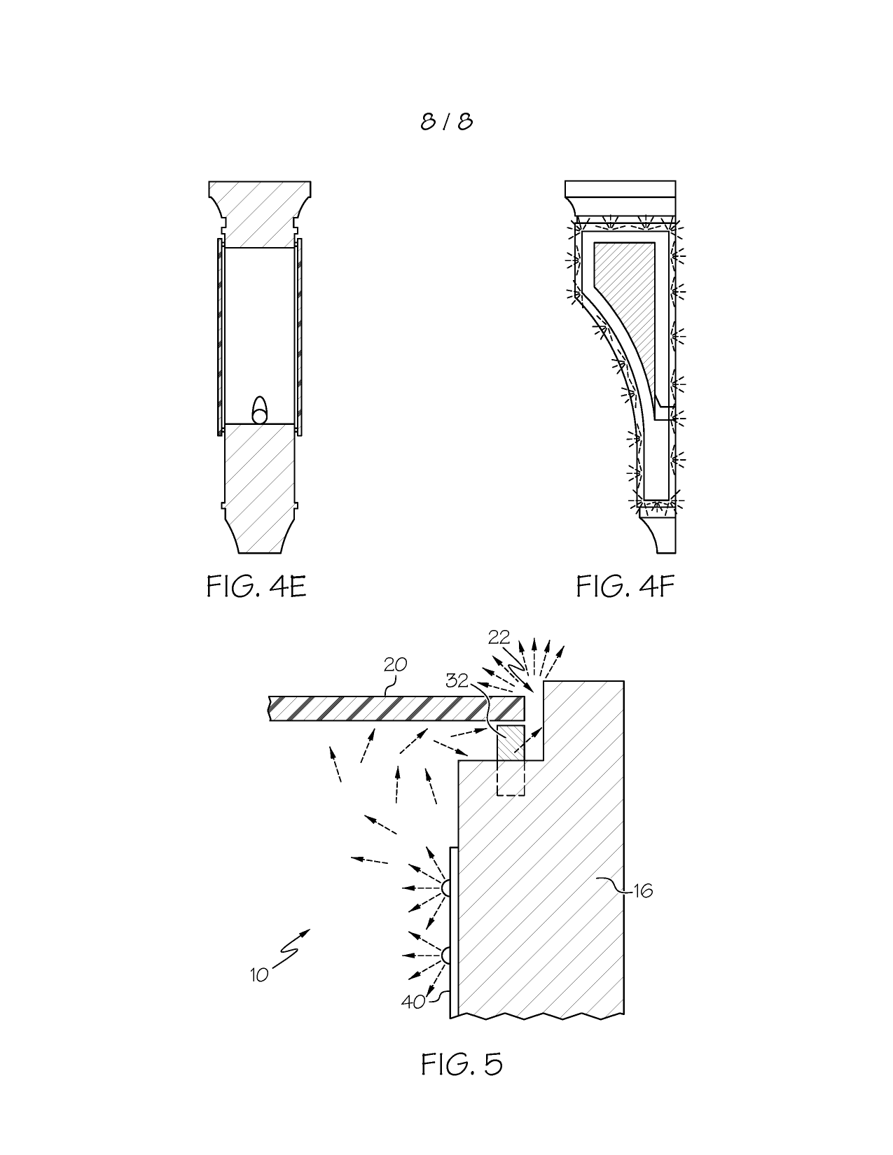

FIGS. 4A through 4F show another example form of the corbel, in this example a longer corbel 100.

While an illuminated corbel is shown and described, it will be appreciated that the invention also relates to similar furniture/architectural elements, such as brackets, feet and legs. While the invention has been shown and described in exemplary forms, it will be apparent to those skilled in the art that many modifications, additions, and deletions can be made therein without departing from the spirit and scope of the invention as defined by the following claims.

What is claimed is:

1. An illuminated corbel comprising:
first and second wood members connected together at proximal ends thereof and extending transverse to one another to form a generally L-shaped structure;
a connecting wood member extending between distal portions of the first and second wood members to define a cavity between the first and second wood members and the connecting member;
at least one wood sheet member substantially covering one side of the cavity; and
one or more electric lamps mounted within the cavity for illuminating the interior of the cavity and wherein the first and second wood members, the connecting wood member, and the sheet member are arranged and configured to permit at least some light from the electric lamp to emanate from the corbel and be externally visible.

2. An illuminated corbel as claimed in claim 1 wherein the sheet member covers the cavity in a manner to avoid sealing the cavity externally against the escape of any light, thus permitting some light to escape from within the cavity.

3. An illuminated corbel as claimed in claim 1 wherein the sheet member is opaque.

4. An illuminated corbel as claimed in claim 1 wherein the sheet member is translucent.

5. An illuminated corbel as claimed in claim 1 wherein the sheet member is fitted within a recess formed in the first and second wood members and the connecting wood member.

6. An illuminated corbel as claimed in claim 5 wherein the sheet member is fitted within a rebate formed in the first and second wood members and the connecting wood member.

7. An illuminated corbel as claimed in claim 1 wherein the one or more electric lamps comprise a strip of LED lamps.

8. An illuminated corbel comprising:
first and second wood members connected together at proximal ends thereof and extending transverse to one another to form a generally L-shaped structure;
a connecting wood member extending between distal portions of the first and second wood members to define a cavity between the first and second wood members and the connecting member;
at least one sheet member substantially covering one side of the cavity; and
one or more electric lamps mounted within the cavity for illuminating the interior of the cavity and wherein the first and second wood members, the connecting wood member, and the sheet member are arranged and configured to permit at least some light from the electric lamp to emanate from the corbel and be externally visible.

9. An illuminated corbel as claimed in claim 1 wherein the sheet member comprises a wood sheet and covers the cavity in a manner to avoid sealing the cavity externally against the escape of any light, thus permitting some light to escape from within the cavity.

10. An illuminated corbel as claimed in claim 1 wherein the sheet member is opaque.

11. An illuminated corbel as claimed in claim 1 wherein the sheet member is translucent.

12. An illuminated corbel as claimed in claim 1 wherein the sheet member is fitted within a recess formed in the first and second wood members and the connecting wood member.

13. An illuminated corbel as claimed in claim 5 wherein the sheet member is fitted within a rebate formed in the first and second wood members and the connecting wood member.

14. An illuminated corbel as claimed in claim 1 wherein the one or more electric lamps comprise a strip of LED lamps.
